(19) United States
(12) Patent Application Publication
(10) Pub. No.: US 2024/0257151 A1
(43) Pub. Date: Aug. 1, 2024

(54) MACHINE-LEARNING FILTERS FOR CONTENT MODERATION AND REPORTING

(71) Applicant: Mercari, Inc., Palo Alto, CA (US)

(72) Inventors: Takuma YAMAGUCHI, Saitama (JP); Vishal KASHYAP, Tokyo (JP); Kosuke ARASE, Tokyo (JP)

(73) Assignee: Mercari, Inc., Palo Alto, CA (US)

(21) Appl. No.: 18/162,982

(22) Filed: Feb. 1, 2023

(51) Int. Cl. G06Q 30/018

(52) U.S. Cl. CPC G06Q 30/018

(57) ABSTRACT

Embodiments described herein include moderating listings on an e-commerce site automatically and reporting to moderators. False positive reporting may be rejected using algorithms and filtering of reporting may be handled. Methods for moderating terms of service (ToS) violations may include receiving indications of a ToS violation, generating values corresponding to the ToS violation based on a machine learning (ML) model and the indications of the ToS violation. The vales may be evaluated to determine an actual ToS violation or false positives. The ML model may be updated based on the values and the indications of a ToS violation.

### TECHNICAL FIELD

This disclosure is generally directed to moderating listings on an e-commerce site automatically and reporting to moderators. False positive reporting may be rejected using algorithms and filtering of reporting may be handled.

### BACKGROUND

A number of e-commerce sites, also known as online marketplaces, exist where users can sell their items. Conventionally, in order to sell on these sites, users must manually create listings for offering their items for sale. The quality of such listings can vary greatly, and may depend on a number of factors, such as the user's experience creating listings, the information the user has on the item (such as make, model, brand, size, color, features, etc.), the user's photo taking skills, whether the user is rushed when creating the listing, whether this is the first time the user has ever tried to sell an item of this type, etc. Since a well-constructed listing will increase the likelihood that the associated item will sell, it would be advantageous if computer technology could be employed to enhance and standardize the quality of listings. With standardization of the listings, moderation of the listings is also necessary.

### SUMMARY

Provided herein are system, apparatus, article of manufacture, method and/or computer program product embodiments, and/or combinations and sub-combinations thereof, for moderating listings on an e-commerce site automatically and reporting to moderators. False positive reporting may be rejected using algorithms and filtering of reporting may be handled.

An example embodiment of the present disclosure includes receiving, via at least one computer processor, at least one indication of a terms of service (ToS) violation. A plurality of values may be generated corresponding to the one or more indications of the ToS violation, via at least one computer processor performing at least one machine-learning (ML) process based at least in part on at least one ML model and the one or more indications of the ToS violation. The plurality of values may include a classification value and a priority score. The plurality of values may be evaluated to yield a first result indicating that the one or more indications of the ToS violation correspond to an actual ToS violation. A second result may be received indicating that the first result is a false positive. The one or more indications of the ToS violation may not correspond to the actual ToS violation. The ML model may be updated responsive to the second result, based at least in part on the second result and the one or more indications of the ToS violation corresponding to the second result.

In some embodiments, the ToS violation is in a listing of an item for sale on an electronic-commerce platform.

In some embodiments, the ToS violation is in a message of a network-enabled chat between two users of an electronic-commerce platform.

In some embodiments, performing an action based on the ToS violation.

In some embodiments, the updating operation is further configured to detect, via the at least one computer processor, a correlation with respect to time, in a plurality of false positives or in a plurality of actual ToS violations.

In some embodiments, the correlation detected is determined to be cyclical.

In some embodiments, the second result is received from a manual-review process, and wherein the at least one indication includes an output of evaluating a text-processing rule, an output of an image classification or image matching, a user-generated flag, or a combination thereof.

An example embodiment of the present disclosure includes a non-transitory computer readable storage medium storing instructions that, when executed by at least one computer processor, cause the at least one computer processor to perform operations. The operations include receiving one or more indications of a ToS violation. The operations further include generating a plurality of values corresponding to the one or more indications of the ToS violation, via at least one machine-learning (ML) process based at least in part on at least one ML model and the one or more indications of the ToS violation with the plurality of values comprises a classification value and a priority score. The operations further include evaluating the plurality of values, to yield a first result indicating that the one or more indications of the ToS violation correspond to an actual ToS violation. The operations further include receiving a second result indicating that the first result is a false positive, with the one or more indications of the ToS violation do not correspond to the actual ToS violation. The operations further include updating the ML model, responsive to the second result, based at least in part on the second result and the one or more indications of the ToS violation corresponding to the second result.

An example embodiment of the present disclosure includes a system including a memory and at least one computer processor coupled to the memory. The at least one computer processor is configured to perform operations including receiving one or more indications of a ToS violation. The operations further include generating a plurality of values corresponding to the one or more indications of the ToS violation, via at least one machine-learning (ML) process based at least in part on at least one ML model and the one or more indications of the ToS violation with the plurality of values comprises a classification value and a priority score. The operations further include evaluating the plurality of values, to yield a first result indicating that the one or more indications of the ToS violation correspond to an actual ToS violation. The operations further include receiving a second result indicating that the first result is a false positive, with the one or more indications of the ToS violation do not correspond to the actual ToS violation. The operations further include updating the ML model, responsive to the second result, based at least in part on the second result and the one or more indications of the ToS violation corresponding to the second result.

### BRIEF DESCRIPTION OF THE FIGURES

The accompanying drawings are incorporated herein and form a part of the specification, illustrate the present disclosure and, together with the description, further serve to explain the principles of the disclosure and enable a person of skill in the relevant art(s) to make and use the disclosure.

FIG. 1 depicts a block diagram of a computing environment that includes an e-commerce site where users can buy and sell items and services, where such items/services are called herein “for sale objects” (FSO), according to some embodiments.

FIG. 2 depicts a process of a system that filters an item listing, according to some embodiments.

FIG. 3 depicts a process of a system that filters a chat, according to some embodiments.

FIG. 4 depicts a dataflow for item moderation, according to some embodiments.

FIG. 5 depicts a dataflow for chat moderation, according to some embodiments.

FIG. 6 depicts an item report filter method using a ML filter model, according to some embodiments.

FIG. 7 depicts a method of moderating listings on an e-commerce site automatically and reporting to moderators, according to some embodiments.

FIG. 8 depicts an example computer system that can be used for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, article of manufacture, method and/or computer program product embodiments, and/or combinations and sub-combinations thereof, for moderating listings on an e-commerce site automatically and reporting to moderators. False positive reporting may be rejected using algorithms and filtering of reporting may be handled.

According to some embodiments, for every seller and potential seller on the e-commerce site, the behavior of the seller should be understood and modelled. The seller's value to the business should be understood, as well as other similar users in order to influence them and draw out more listings and secondary listing recommendations, which could spur the seller or user into listing another item. The user throughout this disclosure may be the seller or the buyer.

According to some embodiments, a seller modeling technology would allow prediction of what sellers do next. This seller modeling technology signals may be embedded into the e-commerce site through customer relationship management (CRM) or suggestions, for example, in a search box or a listing box.

Certain technology outputs may be leveraged to create signals in a product, which may nudge a user or seller to list more items or sell more items efficiently. For example, the e-commerce site would like to increase the listing count for a seller by suggesting what to list next after they have already listed an item. The goal is to suggest complimentary items that may potentially sell well together with the item that they have already listed. Complimentary items may refer to items that are similar in nature, for example by brand or category. The seller may already own the complimentary item, but did not think to list it and the recommendation prods the seller to list an additional item. This suggestion, or recommendation, may lead to an increase in the amount of listings and sales in the e-commerce site, which is advantageous to both the seller and the future buyer.

“For sale objects” (FSO) may be any item, product, object, article, thing, piece, component, sub-component, combination, merchandise, inventory, and/or service that a user wishes to sell via an e-commerce site. When selling items on the e-commerce site, the user is sometimes called a “seller.” When buying items on the e-commerce site, the user is sometimes called a “buyer.” It is noted that a given user can be, at different times, a buyer, a seller, or simultaneously a buyer and a seller.

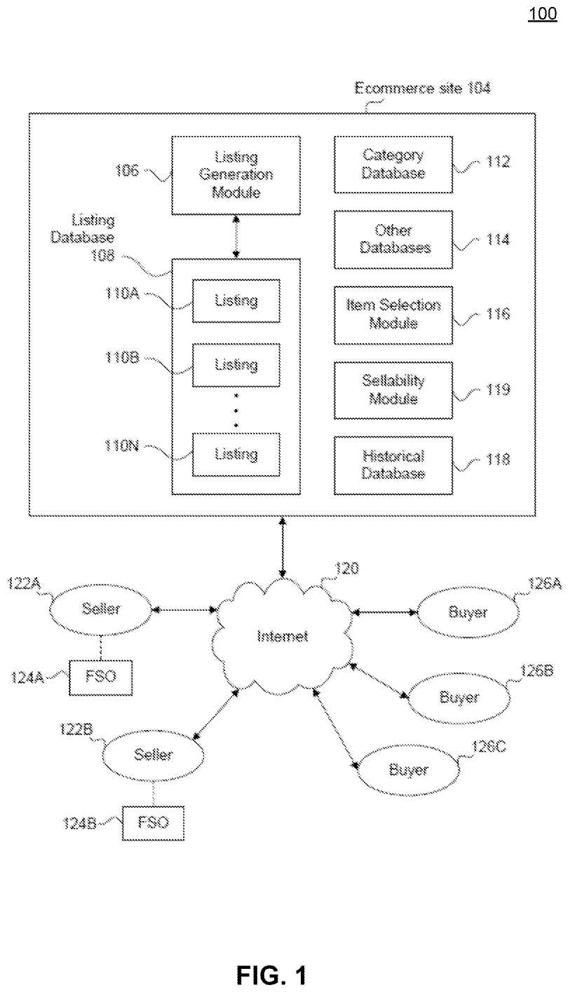

FIG. 1 illustrates a block diagram of a computing environment 100 that includes an e-commerce site 104, also referred to as an e-commerce site, where sellers 122A-122B (herein referred to seller or sellers 122) may sell their FSOs 124A-124B (herein referred to FSO or FSOs 124), and buyers 126A-126C (herein referred to buyer or buyers 126) may buy the FSOs 124. The sellers 122 and buyers 126 can access the e-commerce site 104 via the Internet 120.

The e-commerce site 104 may include a listing database 108 that stores a plurality of listings 110A-110N (herein referred to as listing or listings 110). The listings 110 may be created by sellers 122 to sell their respective FSOs 124 on the e-commerce site 104. To do so, the sellers 122 may interact with a listing generation module 106, which enables sellers 122 to create more consistent, higher quality listings in an automated manner, irrespective of the knowledge, skill or experience of the sellers 122.

The listing generation module 106 may operate with templates that are stored in a template database 114. The templates may be generated and updated by a template generation module 116.

The FSOs 124 may each be associated with a category, such as smartphone, laptop computer, garden tool, men's belt, motorcycle, office desk, woman's purse, and comic books, to name just some examples. These categories are stored in a category database 112.

Each of the listings 110 may have a sellability score that was generated by a sellability module 119. Sellability score is a measure of how likely a given FSO 124 will sell on the e-commerce site 104. For example, the sellability score for a given FSO 124 may be a number between 0 and 1, with the number indicating how likely the FSO 124 will sell on the e-commerce site 104 within a given period of time.

Information that the sellability module 119 may use in generating the sellability score for a given FSO 124 can include information associated with the images in the associated listing 110, such as but not limited to the number of image(s), the quality of the image(s), etc.

Other information that the sellability module 119 may use in generating the sellability score can include a price associated with the FSO 124 (that is, the price that the FSO 124 is being offered for sale). For example, the sellability module 119 may compare the price to the Manufacturer's Suggested Retail Price (MSRP) of items similar to the FSO 124 in determining sellability score. Additional information that the sellability module 119 may use in generating the sellability score can include description information in the listing 110 associated with the FSO 124.

Other information that the sellability module 119 may use in generating the sellability score can include the features associated with the FSO 124. Example features may include, but are not limited to, category, brand, make, model, manufacturer, configuration, customization, color, serial number, condition indicators (e.g., poor, used, like new, new), geographic location, etc.

The sellability module 119 may also consider other information when generating the sellability score for a FSO 124, such as (but not limited to) information associated with the seller 122 of the FSO 124.

The e-commerce site 104 may include a database of historical information 118. The historical information 118 may store information pertaining to listings 110 that sold or did not sell, listings 110 that sold for the highest prices, listings 110 that sold in the shortest amounts of time, listings with the highest sellability scores (as determined by the sellability module 119), the original price and the sale price, descriptions of the associated FSOs 124 (such as make, model, brand, size, color, manufacturer, damage, year, etc.), the number of views of each listing 110, the number and amount of offers for each listing 110, as well as any other information included in the original listings 110 or tracked and collected by the e-commerce site 104 while the listings 110 were active (that is, prior to selling or cancellation) on the e-commerce site 104.

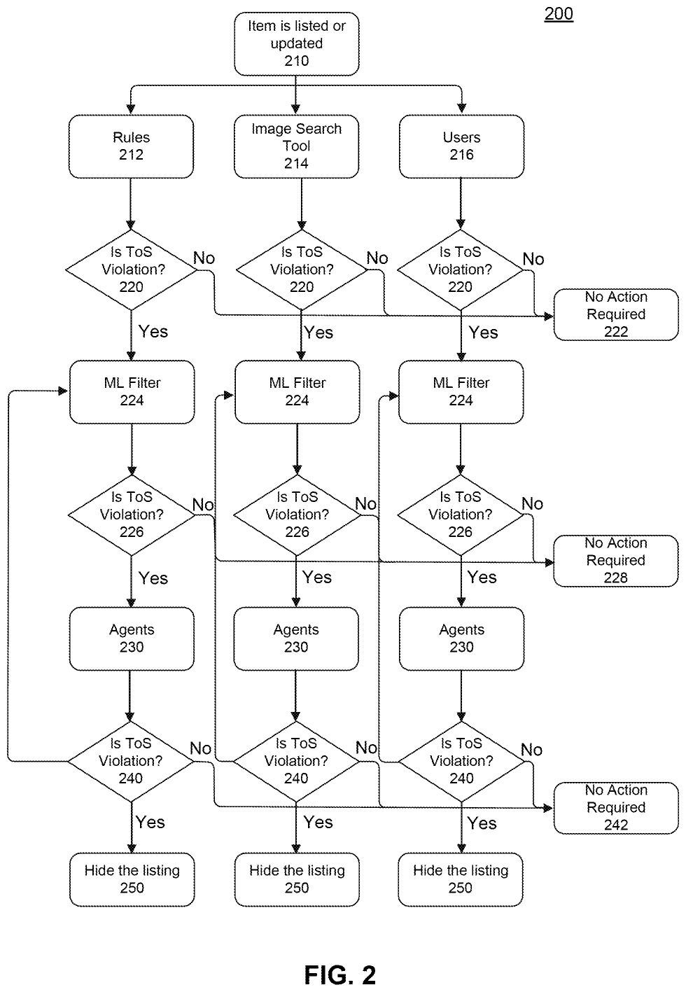

Additionally, the e-commerce site 104 may include a moderation listing module 140. The moderation listing module 140 may moderate listings 110 and/or chats on the e-commerce site 104 automatically and report to moderators. False positive reporting may be rejected using algorithms and filtering of reporting may be handled, which is further described herein. Specifically, the moderation listing module 140 may perform the moderating of listings 110 and/or chats in the e-commerce site 104 using ML techniques as discussed below with respect to FIGS. 2-7.

The advantage of an e-commerce site 104 is that it allows anyone to post a listing 110 to the site. However, this may lead to items being listed that do not comply with set guidelines, whether intentional or unintentional by the seller 122. Due to the listings 110 not meeting guidelines, a need to moderate listings 110 effectively is desired. Carefully chosen rules may assist in detecting such items of listings that should be removed or edited to comply with the guidelines.

The rules may automatically detect the listings 110 that do not comply and are to be reported to internal moderators of the e-commerce site 104. The moderators may then delete the item, ask for mediation, or ignore the report, if the report is false.

The guideline rules may be easily added, which allows for an easy update to the e-commerce site 104 and are reproducible. However, false positive reports may exist. Filtering the false positive reports using fixed regular expressions may lead to very little success and be too complex. Hence, the need for machine learning (ML) algorithms to assist in the filtering process. The guideline rules may be stored in a Structured Query Language (SQL) database and read later during the filtering process. However, the guideline rules can be stored in other databases and/or memory structures to be accessed during the filtering process.

In addition to an internal algorithm, the e-commerce site 104 allows users, both sellers 122 and buyers 126 themselves to report items that they think might violate the guidelines of the e-commerce site 104. As there is an increase in the number of listings 110, an increase of reports from rules and users, but there is a limited number of internal moderators. The necessity to reduce false positive reports may allow for scaling the moderation operations. A hybrid system is proposed in the present disclosure to filter reports and moderate between users.

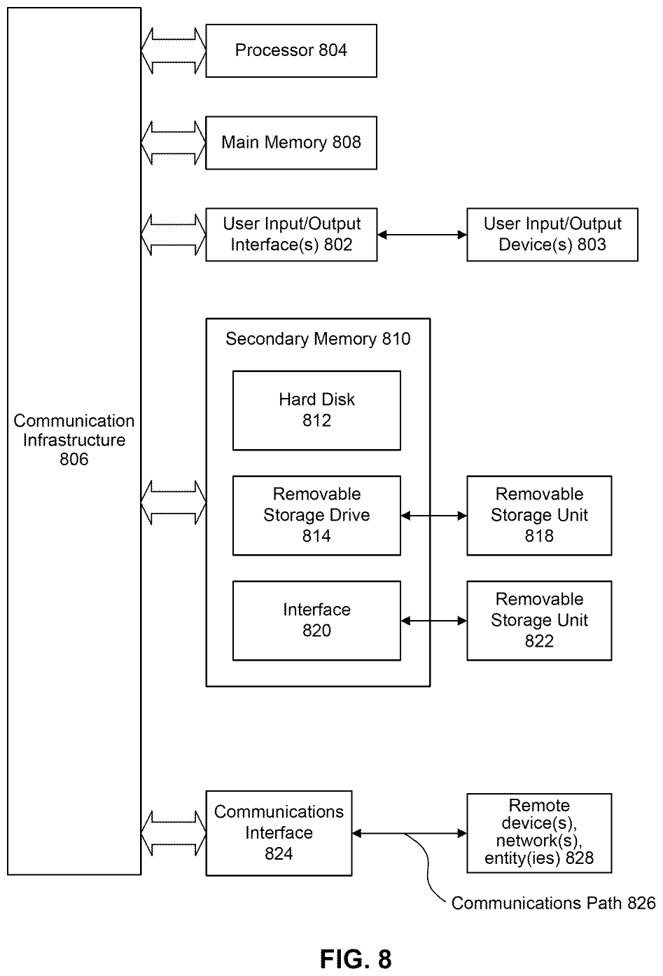

FIG. 2 depicts a process 200 of a system that filters an item listing 110 using a moderation listing module 140, according to some embodiments. As a convenience and not a limitation, FIG. 2 may be described with regard to elements of FIG. 1. Process 200 may represent the operation of moderating listings 110 using the moderation listing module 140 in the e-commerce site 104 using ML techniques. Process 200 may also be performed by computer system 800 of FIG. 8. But process 200 is not limited to the specific aspects depicted in those figures and other systems may be used to perform the method as will be understood by those skilled in the art. It is to be appreciated that not all operations may be needed, and the operations may not be performed in the same order as shown in FIG. 2.

In step 210, the item may be listed or updated on an e-commerce site 104. The listing 110 can include metadata corresponding to the item. The item may then go through three separate operations, which include rules 212, image search tool 214, or users 216. Rules 212 may be set by the e-commerce site 104, the image search tool 214 may be a database of images to be compared with the listing 110, and users 216 may refer to users reporting the item. Additionally, the metadata may be compared using certain key words to the rules 212. When a user 216 reports the listing 110, a list of categories may be chosen by the user 216 to determine the terms of service (ToS) violation. The categories may have assigned classification values based on the category associated with the item. Additionally, a ToS violation may include, but is not limited to, a fake item listing 110, a counterfeit item listing 110, a listing 110 including a weapon, a listing including the sale of alcohol or other forbidden items, etc.

In 220, it is determined whether or not the item is violating a ToS using a ML model. The ML model is based on three separate operations of rules 212, image search tool 214, or users 216. If the ML model determines that there is no violation, the process ends at 222, and no action is required and the item may still be listed. If a violation does occur according to the ML model, the item may proceed through a ML filter 224. This violation at 220 may also be referred to as a first result.

With the ML filter 224, it is further determined whether a ToS violation 226 may have occurred. The ToS violation 226 goes through the ML filter 224 for further processing. If the ML filter decides there is no violation, the process ends at 228, and no action is required and the item may still be listed. If a violation does occur according to the ML filter, the item may be forwarded to agents 230 for further processing. This violation at 226 may also be referred to as a second result.

With the agents 230, it is determined whether a ToS violation 240 may have occurred. According to some embodiments, the agents 230 are humans who make the decision of whether or not the ToS violation 240 violates the guidelines of the e-commerce site 104. Since the agents 230 are humans, they know if the listing 110 is in violation based on the guidelines. If the agent 230 decides there is no violation, the process ends at 242, and no action is required and the item may still be listed. If a violation does occur according to the agent 230, the item may be hidden 250 and no longer accessible. According to some embodiments, the item is hidden and the user is notified that its item has been hidden with the reason(s) behind hiding the item. In some examples, the user can claim this action and escalate it to a moderation agent (e.g., part of agents 230). In some implementations, a threshold may be set for the number of the items that have been hidden within a certain time period for each user. If the user has more items hidden than the set threshold, the user may be suspended from creating listings or from the e-commerce site 104 completely.

Additionally, the agents 230 may manage the rules 212. Although some examples are discussed with respect to humans as agents 230, the embodiments of this disclosure are not limited to these examples and agents 230 can include software and/or hardware configured to evaluate the ToS violations.

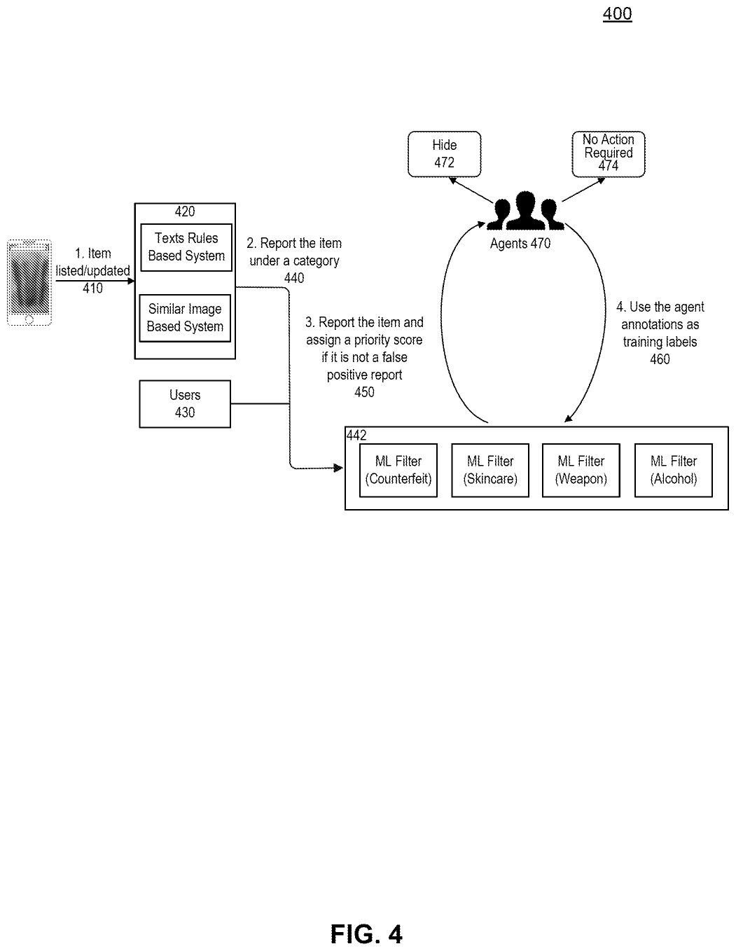

A feedback loop is also present in ToS violation 240. The agents 334 may consistently report the ToS violation 240 and result thereof back to the ML model such that the ML model improves based on the agents 230 decisions. Furthermore, using this continuous feedback loop, which is further depicted in FIG. 4, the agents 230 may validate output and correct inaccurate predictions from the ML filter models. Additionally, the continuous feedback loop may be performed at no additional operational cost.

Here, the cyclical nature of the process may also be observed, as in the ToS violation 240, it may be sent back through the ML filter 224 to improve the ML model. The model may be improved because constant feedback is given and improves the accuracy of the report and the report not being a false positive.

Additionally, it should be noted that at ToS violations 220, 226, and 240, it is the same ToS violation, but the violation is at different steps in the process 200. The ToS violations 220, 226, and 240 goes through multiple iterations to cut down on false positives being reported.

A specific example of an item listing 110 may be, for example, an item listing 110 that is of a handbag or a purse that is not a high-end label, but a fake version of a high-end label. The item listing image may be compared using the image search tool 214 and it can be determined that a logo is similar, but altered. If the ML filter cannot determine if a ToS violation 226 has occurred, it may be forwarded to an agent 230. The agent 230 may determine if a ToS violation 240 has occurred. The item may either be hidden 250 or still be listed (step 242) based on the agents 230 determination.

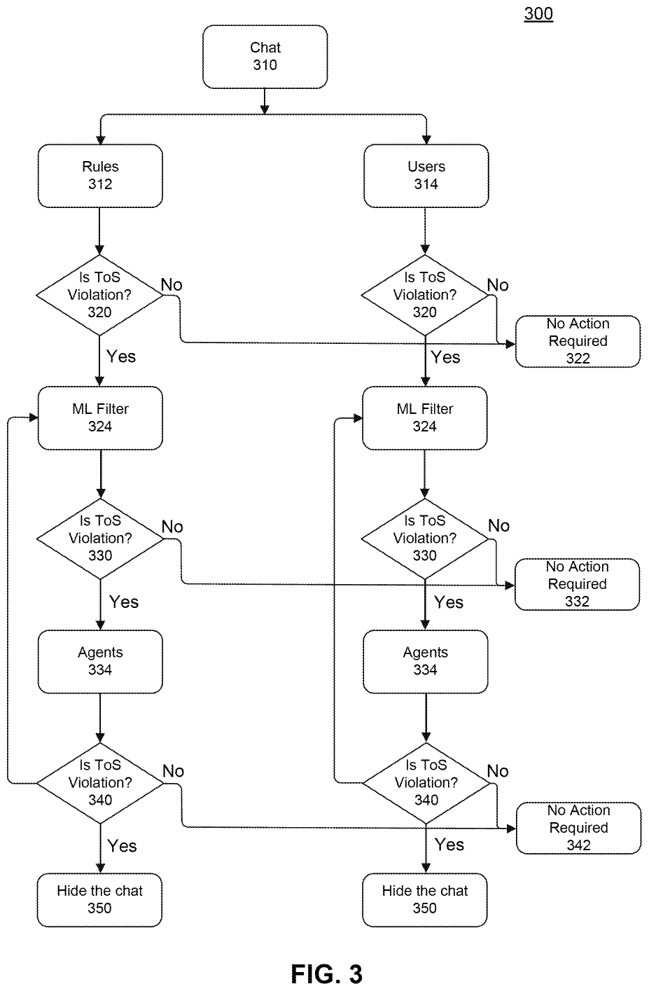

FIG. 3 depicts a process 300 of system that filters a chat using a moderation listing module 140, according to some embodiments. As a convenience and not a limitation, FIG. 3 may be described with regard to elements of FIGS. 1 and 2. Process 300 may represent the operation of moderating chats using the moderation listing module 140 between users in the e-commerce site 104 using ML techniques. Process 300 may also be performed by computer system 800 of FIG. 8. But Process 300 is not limited to the specific aspects depicted in those figures and other systems may be used to perform the method as will be understood by those skilled in the art. It is to be appreciated that not all operations may be needed, and the operations may not be performed in the same order as shown in FIG. 3.

In 310, a chat may exist between users. According to some embodiments, the chat can be associated with an item listed on the e-commerce site 104 and the users can be the seller 122 and the buyer 126. However, the embodiments of this disclosure can include other chats. The chat may then go through two separate operations, which include rules 312 or users 314. Rules 312 may be set by the e-commerce site 104 and users 314 may refer to users reporting the chat. Additionally, the chat may be compared using certain key words to the rules 312. When a user 314 reports the chat, for example, in the app or webpage of the e-commerce site 104, a list of categories may be chosen by the user 314 to determine the ToS violation. The categories may have assigned classification values based on the category associated with the item. Additionally, a ToS violation may include, but is not limited to, a chat including unsolicited information, private information, abusive language, hate speech, solicitation, inappropriate content, etc.

In 320, it is determined whether the chat is violating a ToS using a ML model. The ML model is based on the operations of rules 312 or users 314. If the ML model determines that there is no violation, the process ends at 322, and no action is required and the chat may still exist. If a violation does occur according to the ML model, the chat may proceed through a ML filter 324. This violation at 320 may also be referred to as a first result.

With the ML filter 324, it is further determined whether a ToS violation 330 may have occurred. The ToS violation 226 goes through the ML filter 224 for further processing. If the ML filter decides there is no violation, the process ends at 332, and no action is required and the chat may still exist. If a violation does occur according to the ML filter, the item may be forwarded to agents 334 for further processing. This violation at 226 may also be referred to as a second result.

With the agents 334, it is determined whether a ToS violation 340 may have occurred. According to some embodiments, the agents 334 are humans who make the decision of whether or not the ToS violation 340 violates the guidelines of the e-commerce site 104. Since the agents 334 are humans, they know if the listing 110 is in violation based on the guidelines. If the agent 334 decides there is no violation, the process ends at 342, and no action is required and the chat may still exist. If a violation does occur according to the agent 334, the chat may be hidden 350 and no longer accessible. Additionally, the agents 334 may manage the rules 312. Although some examples are discussed with respect to humans as agents 334, the embodiments of this disclosure are not limited to these examples and agents 334 can include software and/or hardware configured to evaluate the ToS violations.

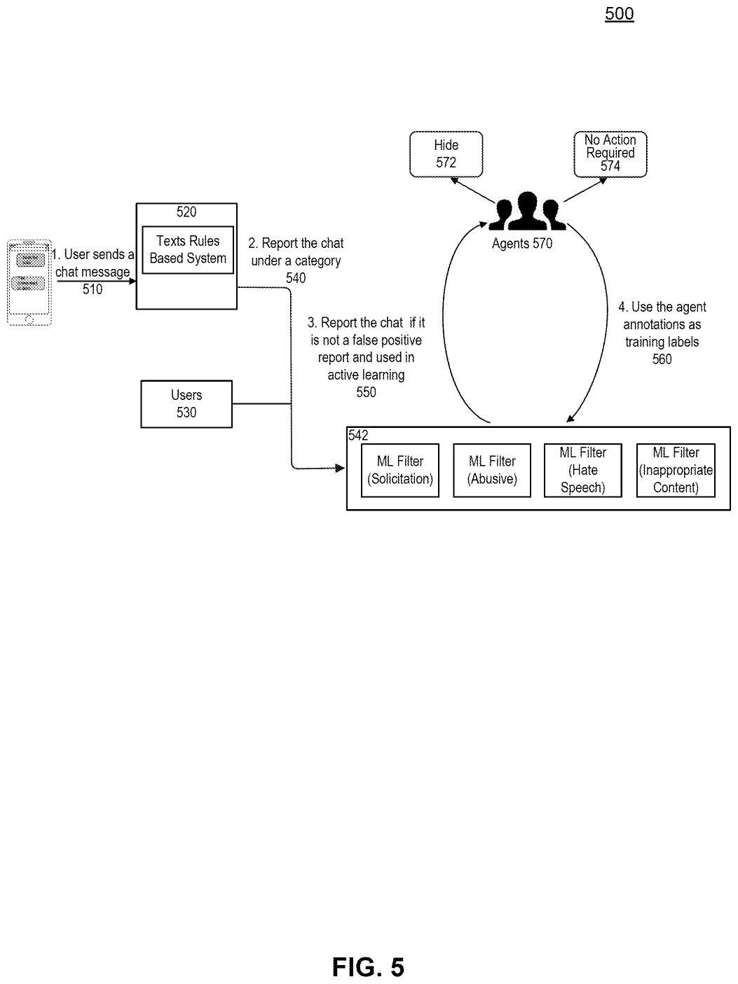

A feedback loop is also present in ToS violation 340. The agents 334 may consistently report the ToS violation 340 and result thereof back to the ML model such that the ML model improves based on the agents 334 decisions. Furthermore, using this continuous feedback loop, which is further depicted in FIG. 5, the agents 334 may validate output and correct inaccurate predictions from the ML filter models. Additionally, the continuous feedback loop may be performed at no additional operational cost.

Here, the cyclical nature of the process may also be observed, as the in the ToS violation 340, it may be sent back through the ML filter 324 to improve the ML model. The model may be improved because constant feedback is given and improves the accuracy of the report and the report not being a false positive.

Additionally, it should be noted that at ToS violations 320, 330, and 340, it is the same ToS violation, but the violation is at different steps in the process 300. The ToS violations 320, 330, and 340 goes through multiple iterations to cut down on false positives being reported.

A specific example of chat violation may be, for example, whether the chat contains inappropriate content, such as sharing a phone number or bank account information. The chat may have been reported by a user 314. It is determined if a ToS violation 320 occurred and if it cannot be determined, it is sent to the ML filter 324. If the ML filter cannot determine if a ToS violation 330 has occurred, it may be forwarded to an agent 334. The agent 334 may determine if a ToS violation 340 has occurred. The chat may either be hidden 350 or still be listed (step 342) based on the agents 334 determination.

An example of a further consequence than just the chat being hidden is the user in violation may be barred from sending future messages or a “strike” may be added to their profile. Too many strikes may cause a temporary or complete ban from using the e-commerce site 104. Specifically, a threshold may be set for the number of the strikes for each user. In some implementations, the set number can be associated with a predetermined time period. If the user has more strikes than the set threshold (e.g., during the predetermined time period), the user may be suspended from chatting, creating listings, or from the e-commerce site 104 completely.

FIG. 4 depicts a dataflow 400 for item moderation using a moderation listing module 140, according to some embodiments. As a convenience and not a limitation, FIG. 4 may be described with regard to elements of FIGS. 1-3. Dataflow 400 may represent the operation of moderating listings 110 using the moderation listing module 140 in the e-commerce site 104 using ML techniques. Dataflow 400 may also be performed by computer system 800 of FIG. 8. But dataflow 400 is not limited to the specific aspects depicted in those figures and other systems may be used to perform the method as will be understood by those skilled in the art. It is to be appreciated that not all operations may be needed, and the operations may not be performed in the same order as shown in FIG. 4.

In 410, an item may be listed on an e-commerce site 104, or if already listed, the item may be updated. In 420, the listing 110 may then be sent through a variety of predefined rules, which may be grouped under different categories. The categories may have assigned classification values based on the category associated with the item.

The predefined rules may be, for example, text rules based on a system or similar images based on the system. The predefined rules may be regular expression matches on text metadata of the item listing 110 or on some fixed conditions. The fixed conditions may include, for example, a certain price range for certain brands. An image search based tool may detect listings 110 that are in violation by comparing image metadata of the listing 110 with images of previous violating listings or reports. The comparison works when the comparison is of highly similar listings 110.

In 440, the item may be reported under a category 442. The categories 442 may include, but are not limited to, counterfeit, skincare, weapons, alcohol, etc. These categories may act as ML filters as well. Multiple ML filter models may exist for the different categories 442 of reports as the ML filters, which reduces the manual inspections performed by moderation agents 470. Whenever a listing 110 is reported by the rules (operation 420) or a user, (operation 430), the listing 110 is sent to the ML filter model for verification. If the listing 110 is likely to be a false positive, the listing 110 is not forwarded to the moderation agent 470 and may be ignored. The ML filter model may be trained on past reports with listings 110 that were deleted or hidden by moderation agents 470 under that specific category 442 being positives (referred to as true positives) and listings 110 that were reported, but not deleted as negatives (referred to as false positives).

The ML filter model may be a standard ML model. For example, images of the item may be taken as an input and then information such as price or numerical metadata may be combined into a network to assist in making the final decision.

The ML filter model may then be deployed to filter incoming listing reports from the rule based system (operation 420), similar image search based tool, or users. Based on the prediction by the ML filter model, a priority score may be assigned if the report is not a false positive report. Additionally, a priority score may be assigned to all unfiltered reports. The priority score allows for higher priority reports to be sent to internal moderators 470 quicker.

In 450, if the item is detected by the predefined rules but not filtered by the ML model filter, the listing 110 is then sent to internal moderators 470, or moderation agents, as a report for further inspection. The moderation agent 470 may review the listing 110 based on the order of assigned priority, the priority score. In 460, the moderation agent 470 may make annotations in the report, which can later be used in further training of the models. In 472, the moderation agent 470 may delete or hide the listing 110 based on the listing 110 being in violation of the rule. Otherwise, in 474, the moderation agent 470 may ignore the report. The actions of step 472 or 474 may be used an implicit labels for further continued learning of the ML filters. This may form a continuous feedback loop, as depicted in FIG. 4, where moderation agents 470 may validate output and correct inaccurate predictions from the ML filter models. Additionally, the continuous feedback loop may be performed at no additional operational cost.

Additionally, in 430, the users may report the listing 110 and follow a similar dataflow. The user typically reports the listing 110 if they believe the listing 110 is in violation of the guidelines.

FIG. 5 depicts a dataflow 500 for chat moderation using a moderation listing module 140, according to some embodiments. As a convenience and not a limitation, FIG. 5 may be described with regard to elements of FIGS. 1-4. Dataflow 500 may represent the operation of moderating chats using the moderation listing module 140 between users in the e-commerce site 104 using ML techniques. Dataflow 500 may also be performed by computer system 800 of FIG. 8. But dataflow 500 is not limited to the specific aspects depicted in those figures and other systems may be used to perform the method as will be understood by those skilled in the art. It is to be appreciated that not all operations may be needed, and the operations may not be performed in the same order as shown in FIG. 5. FIG. 5 is similar to FIG. 4, but relates to chat moderation as opposed to item moderation.

In 510, a user may send a chat message to another user. The chat may be reported in at least two ways. For example, in 530, the chat message may be reported to the e-commerce site 104 through a variety of predefined rules that may be grouped under different categories 542. The user may be either the buyer 126 or the seller 122. These categories may include, but are not limited to, solicitation, abusive, hate speech, inappropriate content, etc. The categories may have assigned classification values based on the category associated with the item. In 520, the chat may be detected by the text rules that are based in the system. The rules of 520 may include handmade regular expression matches.

In 540, the predefined rules may report the chat under the categories 542. A ML model may again be used for different categories 542 of reports as filters. When the chat is reported by the rules (operation 520) or the user (operation 530), it may also be sent to the ML models for filtering false positive reports. If the report is likely to be a false positive, the report is not forwarded to the moderation agents 570 and may be ignored. This ML model may use text classification and may be trained on past reports with chats that were deleted or hidden by moderation agents 570 under that moderation category being positives (referred to as true positives) and chats that were reported but were not deleted as negatives (referred to as false positives).

In 550, the chat may be sent to moderation agents 570 for further inspection where the moderation agent 570 may decide on what to do with the chat. Additionally, the ML filter model may be deployed to filter incoming chat reports from the rules based on the system (operation 520) or the user (operation 530). Based on the prediction by the ML filter model, a priority score may be assigned to all unfiltered reports.

The moderation agent 570 may decide on the action to take. In 572, the moderation agent 570 hides the chat as it deemed to fall under one of the categories 542. In 574, the moderation agent 570 may take no action and the chat may stay active.

In 560, the action taken by the moderation agent 570 may be used as an implicit label for further continual learning of ML filters. This may form a continuous feedback loop where the moderation agents 570 validate output and correct inaccurate predictions from the ML filter models. As in FIG. 4, this feedback loop strategy does not add any additional operational costs.

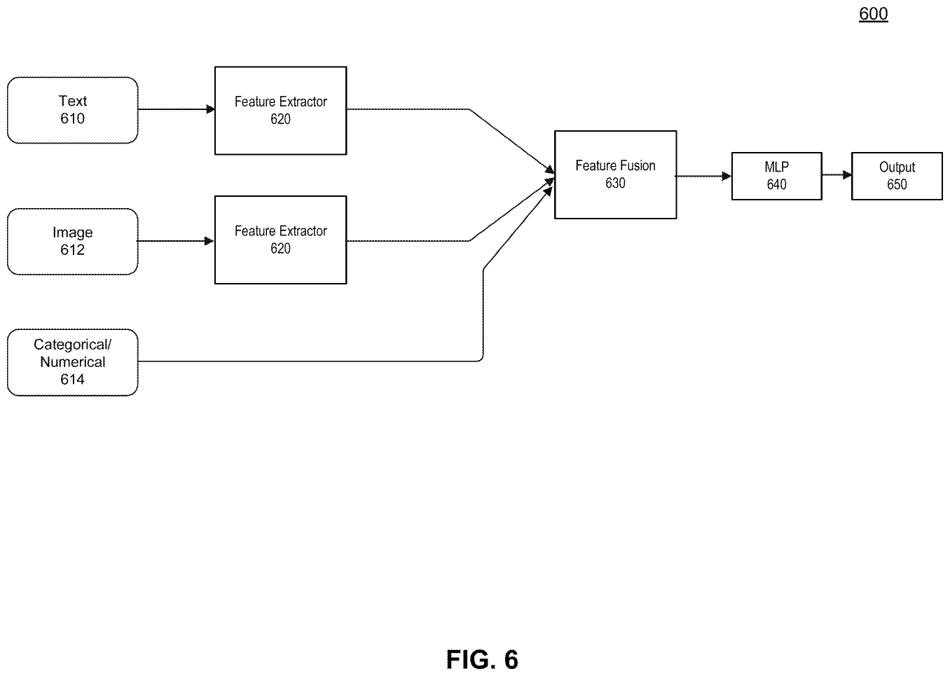

FIG. 6 depicts an item report filter method 600 using a ML filter model, according to some embodiments. As a convenience and not a limitation, FIG. 6 may be described with regard to elements of FIGS. 1-5. Method 600 may represent the operation of filtering an item report based on a violation determined by the moderation listing module 140 in the e-commerce site 104 using ML techniques. Method 600 may also be performed by computer system 800 of FIG. 8. But method 600 is not limited to the specific aspects depicted in those figures and other systems may be used to perform the method as will be understood by those skilled in the art. It is to be appreciated that not all operations may be needed, and the operations may not be performed in the same order as shown in FIG. 6. The ML model filter for item reports may use text, image, or categorical/numerical as features to learn the likelihood of the report being a false positive.

Different metadata such as text 610, image 612, or categorical/numerical 614 may exist. The text metadata 610 and image metadata 612 may be put thru a feature extractor 620. The text 610 and image 612 metadata may be represented in lower dimensional embeddings and may also capture their semantic meaning in the feature extractor 620. These embeddings, along with categorical and numerical features 614, may be fused together using feature fusion 630 to generate a single embedding. The single embedding may then be fed into a multilayer perceptron (MLP) 640. A MLP 640 may be a fully connected class of feedforward artificial neural network. Here, the MLP 640 may be a denser neural network to output 650 the probabilities.

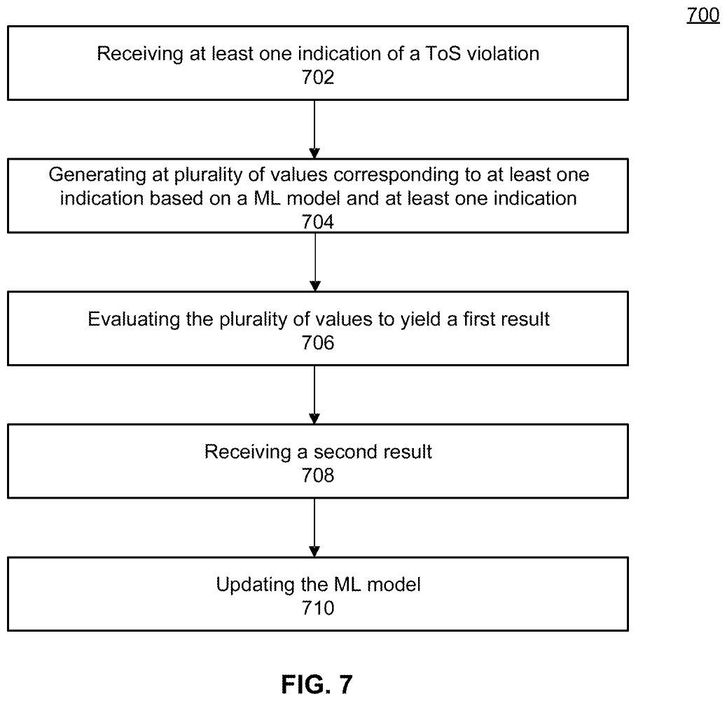

FIG. 7 illustrates a method of moderating listings 110 on an e-commerce site 104 automatically and reporting to moderators or agents, according to some embodiments. As a convenience and not a limitation, FIG. 7 may be described with regard to elements of FIGS. 1-6. Method 700 may represent the operation of the moderation listing module 140 moderating listings in the e-commerce site 104 using ML techniques. Method 700 may also be performed by computer system 800 of FIG. 8. But method 700 is not limited to the specific aspects depicted in those figures and other systems may be used to perform the method as will be understood by those skilled in the art. It is to be appreciated that not all operations may be needed, and the operations may not be performed in the same order as shown in FIG. 7.

In 702, at least one indication of a ToS violation may be received. The ToS may be the rule or guidelines referred to herein. The ToS violation may be in a listing 110 of an item for sale on the e-commerce site 104. Additionally, the ToS violation may be from a chat or message between two users within the e-commerce site 104.

In 704, a plurality of values may be generated. The plurality of values may correspond to the at least one indication of the ToS violation that corresponds to the ToS violation. The generating in 704 may occur via at least one computer processor that may perform at least of ML process based on at least in part at least one ML model and the at least one indications of the ToS violation. The plurality of values may include a classification value and a priority score.

In 706, the plurality of values may be evaluated to yield a first result. The first result may indicate that the at least one indication of the ToS violation corresponds to an actual ToS violation.

In 708, a second result may be received. The second result may indicate that the first result is a false positive. Additionally, the at least one indication of the ToS violation may not correspond to the actual ToS violation. The second result may be received from a manual-review process. The at least one indication may include an output of evaluating a text-processing rule, an output of an image classification or image matching, a user-generated flag, or a combination thereof.

In 710, the ML model may be updated. The updating may be in response to the second result from 708. Additionally, the updating may be based at least in part on the second result and the at least one indication of the ToS violation corresponding to the second result. The updating may also further detect a correlation with respect to time in a plurality of false positives or in a plurality of actual ToS violations. This correlation may be cyclical in nature. The updating of the model corresponds to the feedback loops described in FIGS. 2-5.

Additionally, based on the indications, a further action may be performed based on the ToS violation. As previously described in FIGS. 2-5, a listing may be hidden, a chat disabled, or it can be determined that no ToS violation occurred. For example, a threshold may be set for the strikes for each user where their listing was hidden, chat disabled, or they had a ToS violation. If the user has more strikes than the set threshold, the user may be suspended from chatting, creating listings, or from the e-commerce site 104 completely.

### Example Computer System

Various embodiments may be implemented, for example, using one or more well-known computer systems, such as computer system 800 shown in FIG. 8. For example, the e-commerce site 104 may be implemented using combinations or sub-combinations of computer system 800. Also or alternatively, one or more computer systems 800 may be used, for example, to implement any of the embodiments discussed herein, as well as combinations and sub-combinations thereof.

Computer system 800 may include one or more processors (also called central processing units, or CPUs), such as a processor 804. Processor 804 may be connected to a communication infrastructure or bus 806.

Computer system 800 may also include user input/output device(s) 803, such as monitors, keyboards, pointing devices, etc., which may communicate with communication infrastructure 806 through user input/output interface(s) 802.

One or more of processors 804 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 800 may also include a main or primary memory 808, such as random access memory (RAM). Main memory 808 may include one or more levels of cache. Main memory 808 may have stored therein control logic (i.e., computer software) and/or data.

Computer system 800 may also include one or more secondary storage devices or memory 810. Secondary memory 810 may include, for example, a hard disk drive 812 and/or a removable storage device or drive 814. Removable storage drive 814 may be a floppy disk drive, a magnetic tape drive, a compact disk drive, an optical storage device, tape backup device, and/or any other storage device/drive.

Removable storage drive 814 may interact with a removable storage unit 818. Removable storage unit 818 may include a computer usable or readable storage device having stored thereon computer software (control logic) and/or data. Removable storage unit 818 may be a floppy disk, magnetic tape, compact disk, DVD, optical storage disk, and/any other computer data storage device. Removable storage drive 814 may read from and/or write to removable storage unit 818.

Secondary memory 810 may include other means, devices, components, instrumentalities or other approaches for allowing computer programs and/or other instructions and/or data to be accessed by computer system 800. Such means, devices, components, instrumentalities or other approaches may include, for example, a removable storage unit 822 and an interface 820. Examples of the removable storage unit 822 and the interface 820 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 800 may further include a communication or network interface 824. Communication interface 824 may enable computer system 800 to communicate and interact with any combination of external devices, external networks, external entities, etc. (individually and collectively referenced by reference number 828). For example, communication interface 824 may allow computer system 800 to communicate with external or remote devices 828 over communications path 826, which may be wired and/or wireless (or a combination thereof), and which may include any combination of LANs, WANs, the Internet, etc. Control logic and/or data may be transmitted to and from computer system 800 via communication path 826.

Computer system 800 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 800 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 800 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 800, main memory 808, secondary memory 810, and removable storage units 818 and 822, as well as tangible articles of manufacture embodying any combination of the foregoing. Such control logic, when executed by one or more data processing devices (such as computer system 800 or processor(s) 804), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 8. In particular, embodiments can operate with software, hardware, and/or operating system implementations other than those described herein.

### CONCLUSION

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method for moderating terms of service (ToS) violations, the computer-implemented method comprising:
receiving, via at least one computer processor, one or more indications of a ToS violation;
generating a plurality of values corresponding to the one or more indications of the ToS violation, via the at least one computer processor performing at least one machine-learning (ML) process based at least in part on at least one ML model and the one or more indications of the ToS violation, wherein the plurality of values comprises a classification value and a priority score;
evaluating, via the at least one computer processor, the plurality of values to yield a first result indicating that the one or more indications of the ToS violation correspond to an actual ToS violation;
receiving, via the at least one computer processor, a second result indicating that the first result is a false positive, wherein the one or more indications of the ToS violation do not correspond to the actual ToS violation; and
updating, via the at least one computer processor, the ML model, responsive to the second result, based at least in part on the second result and the one or more indications of the ToS violation corresponding to the second result.

2. The computer-implemented method of claim 1, wherein the ToS violation is in a listing of an item for sale on an electronic-commerce platform.

3. The computer-implemented method of claim 1, wherein the ToS violation is in a message of a network-enabled chat between two users of an electronic-commerce platform.

4. The computer-implemented method of claim 1, further comprising: performing an action based on the ToS violation.

5. The computer-implemented method of claim 1, wherein the updating further comprises detecting, via the at least one computer processor, a correlation with respect to time, in a plurality of false positives or in a plurality of actual ToS violations.

6. The computer-implemented method of claim 5, wherein the detecting the correlation further comprises determining that the correlation is cyclical.

7. The computer-implemented method of claim 1, wherein the receiving the second result comprises receiving the second result from a manual-review process, and wherein the one or more indications comprise an output of evaluating a text-processing rule, an output of an image classification or image matching, a user-generated flag, or a combination thereof.

8. A non-transitory computer readable storage medium storing instructions for moderating terms of service (ToS) violations, that, when executed by at least one computer processor, cause the at least one computer processor to perform operations comprising:
receiving one or more indications of a ToS violation;
generating a plurality of values corresponding to the one or more indications of the ToS violation, via at least one machine-learning (ML) process based at least in part on at least one ML model and the one or more indications of the ToS violation, wherein the plurality of values comprises a classification value and a priority score;
evaluating the plurality of values, to yield a first result indicating that the one or more indications of the ToS violation correspond to an actual ToS violation;
receiving a second result indicating that the first result is a false positive, wherein the one or more indications of the ToS violation do not correspond to the actual ToS violation; and
updating the ML model, responsive to the second result, based at least in part on the second result and the one or more indications of the ToS violation corresponding to the second result.

9. The non-transitory computer readable storage medium of claim 8, wherein the ToS violation is in a listing of an item for sale on an electronic-commerce platform.

10. The non-transitory computer readable storage medium of claim 8, wherein the ToS violation is in a message of a network-enabled chat between two users of an electronic-commerce platform.

11. The non-transitory computer readable storage medium of claim 8, further comprising: performing an action based on the ToS violation.

12. The non-transitory computer readable storage medium of claim 8, wherein the updating further comprises detecting, via the at least one computer processor, a correlation with respect to time, in a plurality of false positives or in a plurality of actual ToS violations.

13. The non-transitory computer readable storage medium of claim 12, wherein the detecting the correlation comprises determining that the correlation is cyclical.

14. The non-transitory computer readable storage medium of claim 8, wherein the receiving the second result comprises receiving the second result from a manual-review process, and wherein the one or more indications comprise an output of evaluating a text-processing rule, an output of an image classification or image matching, a user-generated flag, or a combination thereof.

15. A system for moderating terms of service (ToS) violations, comprising:
a memory; and
at least one computer processor coupled to the memory and configured to perform operations comprising:
receiving one or more indications of a ToS violation;
generating a plurality of values corresponding to the one or more indications of the ToS violation, via at least one machine-learning (ML) process based at least in part on at least one ML model and the one or more indications of the ToS violation, wherein the plurality of values comprises a classification value and a priority score;
evaluating the plurality of values, to yield a first result indicating that the one or more indications of the ToS violation correspond to an actual ToS violation;
receiving a second result indicating that the first result is a false positive, wherein the one or more indications of the ToS violation do not correspond to the actual ToS violation; and
updating the ML model, responsive to the second result, based at least in part on the second result and the one or more indications of the ToS violation corresponding to the second result.

16. The system of claim 15, wherein the ToS violation is in a listing of an item for sale on an electronic-commerce platform.

17. The system of claim 15, wherein the ToS violation is in a message of a network-enabled chat between two users of an electronic-commerce platform.

18. The system of claim 15, further comprising: performing an action based on the ToS violation.

19. The system of claim 15, wherein the updating further comprises detecting a correlation with respect to time, in a plurality of false positives or in a plurality of actual ToS violations.

20. The system of claim 15, wherein the second result is received from a manual-review process, and wherein the at least one indication comprises an output of evaluating a text-processing rule, an output of an image classification or image matching, a user-generated flag, or a combination thereof.
